(19) United States
(12) Patent Application Publication
(10) Pub. No.: US 2014/0124993 A1
(43) Pub. Date: May 8, 2014

(54) OFF-GAS CHANNEL

(71) Applicant: Olli Pekkala, Espoo (FI)

(72) Inventor: Olli Pekkala, Espoo (FI)

(73) Assignee: OUTOTEC OYJ, Espoo (FI)

(21) Appl. No.: 14/127,730

(22) PCT Filed: Jun. 14, 2012
(86) PCT No.: PCT/FI2012/050607

§ 371 Date: Dec. 19, 2013

(30) Foreign Application Priority Data
Jun. 29, 2011 (FI) U20114077

(51) Int. Cl. F27D 17/00

(52) U.S. Cl. CPC F27D 17/002; F27D 17/008
USPC 266/147; 266/159

(57) ABSTRACT

An off-gas channel (1) of a closed-type smelting furnace (2), the off-gas channel (1) comprising a first end (3) opening to the upper part of the smelting furnace (2) and a second end (4) opening to a gas cleaning apparatus (5) for leading the furnace off-gases to the gas cleaning apparatus. The off-gas channel comprises at least one cleaning nozzle (6, 7, 8, 9) adapted to spray pressurized fluid to the inner surface of the off-gas channel.

### FIELD OF THE INVENTION

The invention relates to an off-gas channel of a closed-type smelting furnace. The off-gas channel comprises a first end opening to the upper part of the smelting furnace and a second end opening to a gas cleaning apparatus for leading the furnace off-gases to the gas cleaning apparatus.

### BACKGROUND OF THE INVENTION

In prior art the clogging of the off-gas channel by dust particles which can precipitate on the inner surface of the channel walls obstructing the exit flow of the off-gas from the smelting furnace is one of the most significant factors that reduce the operating time ratio of the smelting furnace. FIG. 2 shows a blockage situation of a prior art off-gas channel 1 in an exemplary situation. Of course, it should be understood that the blocking pattern may not be the same in each smelter. The off-gas channel 1, also called as a gooseneck, comprises, in the direction of the off-gas flow, a substantially upright first end portion 12 the lower first end 3 of which is connected to the smelting furnace 2, a bend portion 13, an inclined portion 14 and a second end portion 15. The off-gas exiting from the smelting furnace 2 contains carbon monoxide, hydrogen, water and dust particles. Accumulation of precipitated dust particles, i.e. the blockage 17, appears especially at the lower part of the inclined portion 14 and also in the second end portion 15 where the gooseneck 1 is connected to the scrubber 5. In practice, when the smelting furnace is a ferrochrome smelting furnace, it has proved to be that, depending on furnace operation, the off-gas channel needs to be cleaned in certain interval, typically below one month.

Each cleaning operation causes an interruption of production of about 1 to 2 hours which causes financial losses. The bigger the furnace is, the greater is the financial loss.

### OBJECT OF THE INVENTION

It is an object of the invention to overcome the disadvantages of the prior art as outlined above.

### SUMMARY OF THE INVENTION

According to the invention the off-gas channel comprises at least one cleaning nozzle adapted to spray pressurized fluid to the inner surface of the off-gas channel.

The advantage of the invention is that the off-gas channel can be cleaned from accumulated dust particles by the spray of fluid and/or gas. The fluid to be sprayed can be liquid and/or gas. Water and nitrogen gas are suitable fluids for this purpose, for example. The fluid can be sprayed continuously or periodically (e.g. once per day, twice per day etc.) to keep the off-gas channel clean. The blockages can be avoided and the down time of the furnace can be reduced. Less time is needed for maintenance. The additional nozzles in the off-gas channel also reduce the off-gas temperature and binds some dust and thus make the gas cleaning more efficient.

In one embodiment, the gas cleaning apparatus is a venturi scrubber comprising an upright ejector venturi tube having an upper end. The second end of the off-gas channel is connected to the upper end of the venturi tube.

In one embodiment, the off-gas channel is a gooseneck channel comprising, in the direction of the off-gas flow, a substantially upright first end portion the lower first end of which is connected to the smelting furnace, a bend portion, an inclined portion and a second end portion having a roof.

In one embodiment, the off-gas channel comprises a first cleaning nozzle, which is connected at the wall of the bend portion and adapted to spray pressurized liquid onto the inner surface of the inclined portion.

In one embodiment, the off-gas channel comprises a second cleaning nozzle which is connected at the roof of the second end portion and adapted to spray pressurized liquid onto the inner surfaces of the second end portion and the connection between the second end portion and the venturi tube.

In one embodiment, the off-gas channel comprises a third cleaning nozzle which is connected at the upper end of the inclined portion and adapted to spray pressurized liquid onto the inner surface of the lower wall portion the inclined portion.

In one embodiment the off-gas channel comprises a plurality of fourth cleaning nozzles which are connected at the inclined portion and adapted to spray pressurized gas onto the inner surface of the lower wall portion of the inclined portion.

### BRIEF DESCRIPTION OF THE DRAWINGS

The accompanying drawings, which are included to provide a better understanding of the invention constitute part of the description, illustrate preferred embodiments of the invention and help to explain the principles of the invention.

FIG. 1 shows schematically a smelting furnace, a gas cleaning apparatus and an off-gas channel for leading off-gas exiting from the smelting furnace to the gas cleaning apparatus,

FIG. 2 shows in cross-section a prior art off-gas channel the first end of which is connected to the smelting furnace and the second end being connected to a gas cleaning apparatus,

FIG. 3 shows in cross-section an off-gas channel of the first embodiment of the invention the first end of which is connected to the smelting furnace and the second end being connected to a gas cleaning apparatus, and

FIG. 4 shows in cross-section an off-gas channel of the second embodiment of the invention the first end of which is connected to the smelting furnace and the second end being connected to a gas cleaning apparatus.

### DETAILED DESCRIPTION OF THE INVENTION

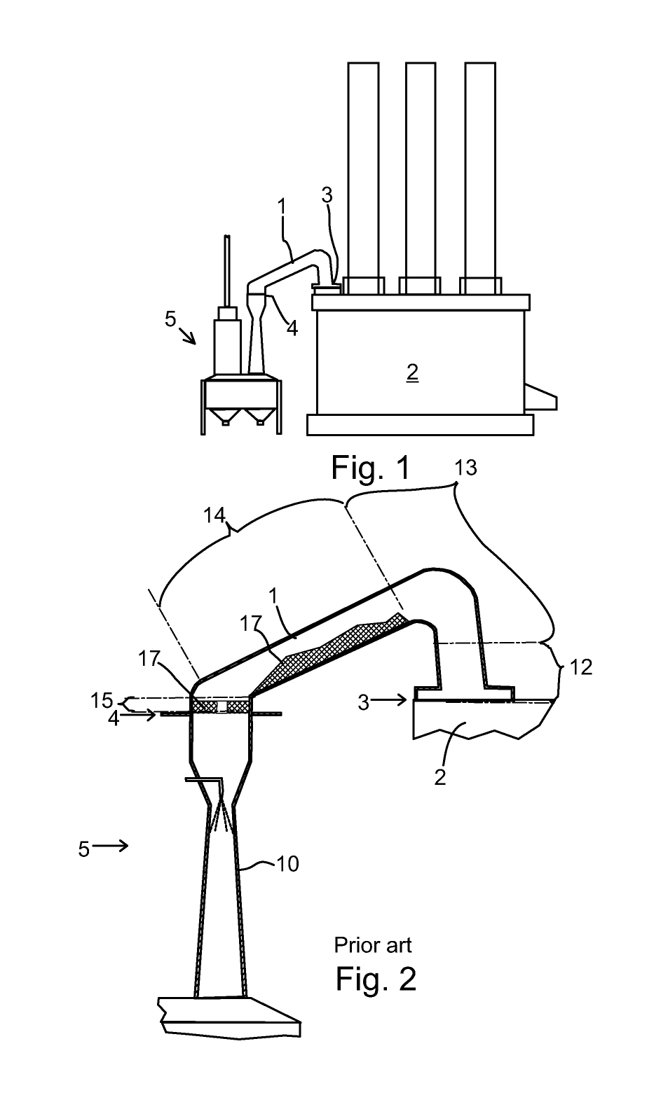

Referring to FIG. 1 there is a schematical illustration of an arrangement of a smelting furnace 2, an off-gas channel 1 and a gas cleaning apparatus 5. The smelting furnace 5 is a closed-type submerged arc furnace. The off-gas which exits via the off-gas channel 1 contains mainly CO gas and dust and also hydrogen and water. The off-gas channel 1 comprises a first end 3 which opens to the upper part of the smelting furnace 2. The second end 4 of the off-gas channel 1 opens to a gas cleaning apparatus 5 for leading the furnace off-gases to the gas cleaning apparatus.

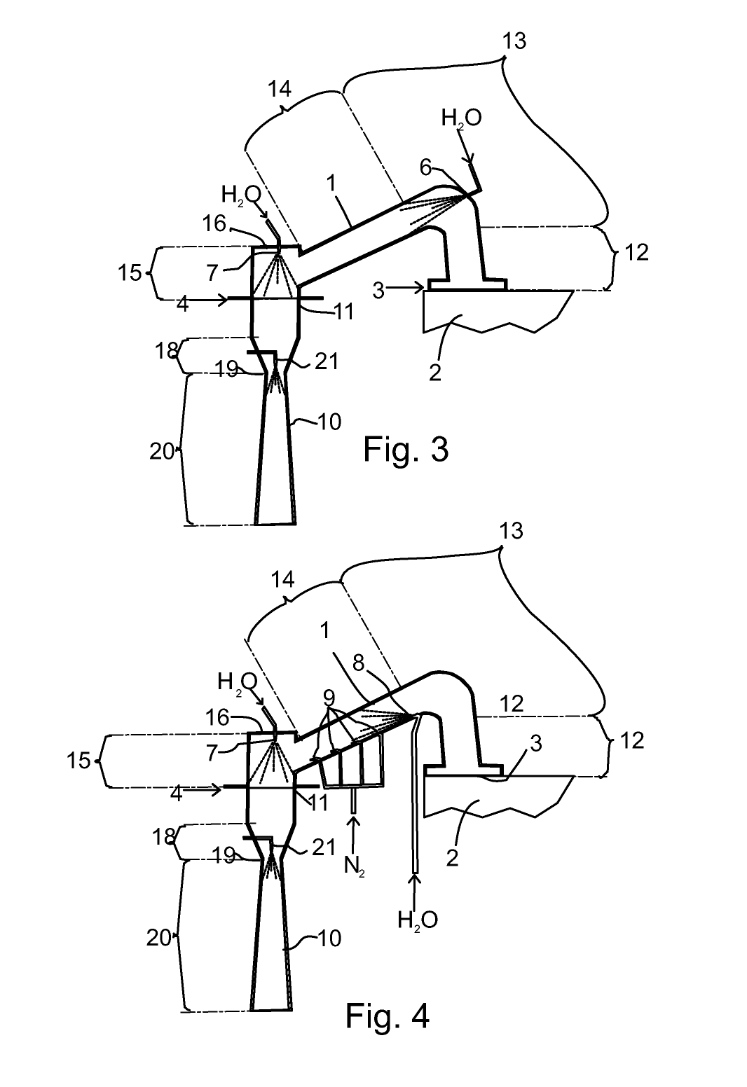

Referring to FIGS. 3 and 4 the off-gas channel 1 comprises at least one cleaning nozzle 6, 7, 8, 9 adapted to spray pressurized fluid onto the inner surface of the off-gas channel 1. Preferably, there is arranged at least two cleaning nozzles. The cleaning nozzles are disposed to wash the whole inner surface of the off-gas channel 1.

The second end 4 of the off-gas channel 1 is connected to the gas cleaning apparatus 5. The gas cleaning apparatus 5 may be a venturi scrubber comprising an upright ejector venturi tube 10. The venturi tube 10 comprises a converging section 18, a throat 19 and a diverging section 20. A nozzle 21 for the injection of water jet is disposed in the throat 19. The venturi tube 10 has an upper end 11. The second end 4 of the off-gas channel 1 is connected to the upper end 11 of the venturi tube 10.

As seen in FIGS. 3 and 4, the off-gas channel 1 is a gooseneck channel. In the direction of the off-gas flow the off-gas channel 1 comprises a substantially upright first end portion 12 the lower first end 3 of which is connected to the smelting furnace 2. The first end portion 12 continues as a bend portion 13 which continues an inclined portion 14 in an acute angle in relation to vertical. Finally, the inclined portion 14 ends up in a second end portion 15 having a roof 16. The second end portion 15 opens downwards and discharges the off-gas to the upper end 11 of the venturi tube 10.

Referring to the embodiment of FIG. 3 there are shown two cleaning nozzles 6 and 7 for spraying pressurized water. A first cleaning nozzle 6 is connected at the wall of the bend portion 13 and adapted to spray pressurized water jet onto the inner surface of the inclined portion 14. A second cleaning nozzle 7 is connected at the roof 16 of the second end portion 15. The second cleaning nozzle 7 is adapted to spray pressurized water jet onto the inner surfaces of the second end portion 15 and the connection between the second end portion 15 and the venturi tube 10. The water jets detach and flush away any clogging accumulated on the inner surface of the off-gas channel 1.

The pressure of the water to be sprayed may e.g. be of the order of 30 bar.

Referring to the embodiment of FIG. 4 there are shown two cleaning nozzles 7 and 8 for spraying pressurized water and a plurality of cleaning nozzles 9 for spraying a gas jet. A second cleaning nozzle 7 is connected at the roof 16 of the second end portion 15. The second cleaning nozzle 7 is adapted to spray pressurized water jet onto the inner surfaces of the second end portion 15 and the connection between the second end portion 15 and the venturi tube 10. A third cleaning nozzle 8 is connected at the upper end of the inclined portion 14. The third cleaning nozzle 8 is adapted to spray pressurized water jet onto the inner surface of the lower wall portion the inclined portion 14. The pressure of the water to be sprayed may e.g. be of the order of 30 bar. Further, the off-gas channel 1 comprises a plurality of fourth cleaning nozzles 9. The fourth cleaning nozzles 9 are connected at the inclined portion 14 and adapted to spray pressurized nitrogen gas onto the inner surface of the lower wall portion of the inclined portion 14. The water jets and nitrogen gas jets detach and flush away any clogging accumulated on the inner surface of the off-gas channel 1.

Also any combination of cleaning nozzle arrangements shown in FIGS. 3 and 4 is possible. The nozzles can be controlled to spray continuously or periodically. Some cleaning nozzles may also spray continuously while the others spray periodically. The cleaning nozzles 6, 7, 8, 9 may be controlled by controlled valves (not shown) to perform the periodical spraying cycle. If water is used as a liquid to be sprayed, the same pump which pumps the water to the nozzle in the venturi tube can be used for pumping the water to the cleaning nozzles.

If the cleaning nozzles 6, 7, 8, 9 are not supposed to be spraying continuously, they must be placed in a cavity inside a water-cooled sleeve to protect the cleaning nozzles from damage when they are not spraying liquid and/or gas.

It is obvious to a person skilled in the art that with the advancement of technology, the basic idea of the invention may be implemented in various ways. The invention and its embodiments are thus not limited to the examples described above; instead they may vary within the scope of the claims.

1. An off-gas channel of a closed-type smelting furnace, the off-gas channel comprising a first end opening to the upper part of the smelting furnace and a second end opening to a gas cleaning apparatus for leading the furnace off-gases to the gas cleaning apparatus, characterized in that the off-gas channel comprises at least one cleaning nozzle adapted to spray pressurized fluid to the inner surface of the off-gas channel.

2. The off-gas channel according to claim 1, characterized in that the gas cleaning apparatus is a venturi scrubber comprising an upright ejector venturi tube having an upper end, and that the second end of the off-gas channel is connected to the upper end of the venturi tube.

3. The off-gas channel according to claim 1, characterized in that the off-gas channel is a gooseneck channel comprising, in the direction of the off-gas flow, a substantially upright first end portion the lower first end of which is connected to the smelting furnace, a bend portion, an inclined portion and a second end portion having a roof.

4. The off-gas channel according to claim 3, characterized in that the off-gas channel comprises a first cleaning nozzle, which is connected at the wall of the bend portion and adapted to spray pressurized liquid onto the inner surface of the inclined portion.

5. The off-gas channel according to claim 3, characterized in that the off-gas channel comprises a second cleaning nozzle which is connected at the roof of the second end portion and adapted to spray pressurized liquid onto the inner surfaces of the second end portion and the connection between the second end portion and the venturi tube.

6. The off-gas channel according to claim 3, characterized in that the off-gas channel comprises a third cleaning nozzle which is connected at the upper end of the inclined portion and adapted to spray pressurized liquid onto the inner surface of the lower wall portion of the inclined portion.

7. The off-gas channel according to claim 3, characterized in that the off-gas channel comprises a plurality of fourth cleaning nozzles which are connected at the inclined portion and adapted to spray pressurized gas onto the inner surface of the lower wall portion of the inclined portion.
